(19) United States
(12) Patent Application Publication
(10) Pub. No.: US 2017/0101347 A1
(43) Pub. Date: Apr. 13, 2017

(54) METHOD FOR COATING REMOVAL

(71) Applicant: GENERAL ELECTRIC COMPANY, SCHENECTADY, NY (US)

(72) Inventors: Julin Wan, Rexford, NY (US); Hongbo Cao, Cohoes, NY (US)

(21) Appl. No.: 14/878,192

(22) Filed: Oct. 8, 2015

(51) Int. Cl. C04B 41/00; B08B 7/04

(52) U.S. Cl. CPC C04B 41/0072; B08B 7/04

(57) ABSTRACT

A method for removing a coating from an article includes heating an article to a processing temperature. The article includes a first material in contact with a second material, the first material comprising silicon, and the second material comprising an oxide comprising silicon. The heating is performed in an environment having a partial pressure of oxygen that is less than an equilibrium partial pressure of oxygen for chemical equilibrium between the first material and the second material at the processing temperature.

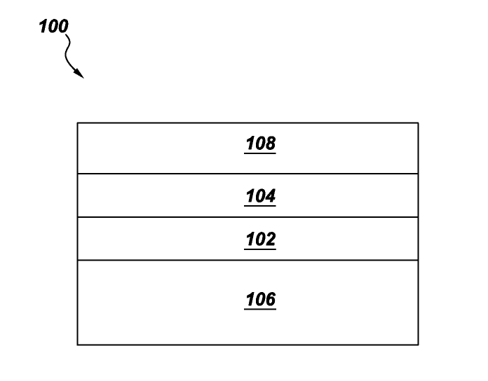

### BACKGROUND

This disclosure generally relates to materials and articles for service in high-temperature applications such as, for example, turbomachinery. More specifically, this disclosure relates to methods for removing coatings from ceramic-matrix composite substrates.

Ceramic matrix composite (CMC) materials offer the potential for higher operating temperatures than do metal alloy materials due to the inherent high-temperature material properties of ceramic materials. In applications such as gas turbine assemblies, this capability may be translated into a reduced cooling requirement which, in turn, may result in higher power, greater efficiency, and/or reduced emissions from the machine. However, CMC materials that include significant amounts of silicon-bearing materials, such as silicon carbide or silicon nitride, are susceptible to attack and rapid recession by water vapor at elevated service temperatures. Environmental barrier coatings (EBC) have been developed to inhibit this degradation mechanism.

During service, one or more portions of the EBC may become damaged, but because CMC components typically are expensive, removing the damaged EBC and re-coating the used CMC component is economically advantageous over replacing the entire component. EBC's can be removed by mechanical processes such as grit blasting, but such operations may lead to damage of the CMC substrate due to the desirably strong bonding between CMC and EBC.

There is thus a need in the industry for methods for removing coatings such as EBC from CMC substrates without unduly damaging the CMC material.

### BRIEF DESCRIPTION

Embodiments of the present invention are provided to meet this and other needs. One embodiment is a method for removing a coating from an article. The method includes heating an article to a processing temperature. The article includes a first material in contact with a second material, the first material comprising silicon, and the second material comprising an oxide comprising silicon. The heating is performed in an environment having a partial pressure of oxygen that is less than an equilibrium partial pressure of oxygen for chemical equilibrium between the first material and the second material at the processing temperature.

Another embodiment is a method for removing a coating from an article. The method includes heating the article to a processing temperature at least about 1200 degrees Celsius in a vacuum having a total pressure less than about 10⁻² torr (1.3 Pa). The article includes a substrate comprising a ceramic matrix composite, the composite comprising silicon carbide, silicon nitride, or a combination comprising one or both of the aforementioned; a first material disposed over the substrate and including elemental silicon, an alloy comprising elemental silicon, a silicide, or a combination comprising one or more of the aforementioned; a second material in contact with the first material, the second material comprising silica, a silicate, or a combination comprising one or both of the aforementioned, and a third material disposed over the second material, the third material comprising a rare earth silicate, an aluminosilicate, zirconia, or a combination comprising one or more of the aforementioned. The article is heated at the processing temperature in the described environment until a desired degree of reaction between first material and second material has occurred, and then the third material is removed from substrate.

### DRAWINGS

These and other features, aspects, and advantages of the present invention will become better understood when the following detailed description is read with reference to the accompanying drawing in which like characters represent like parts, wherein:

The FIGURE is a schematic cross-section of an article treated in accordance with the description herein.

### DETAILED DESCRIPTION

Approximating language, as used herein throughout the specification and claims, may be applied to modify any quantitative representation that could permissibly vary without resulting in a change in the basic function to which it is related. Accordingly, a value modified by a term or terms, such as “about”, and “substantially” is not to be limited to the precise value specified. In some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

In the following specification and the claims, the singular forms “a”, “an” and “the” include plural referents unless the context clearly dictates otherwise. As used herein, the term “or” is not meant to be exclusive and refers to at least one of the referenced components being present and includes instances in which a combination of the referenced components may be present, unless the context clearly dictates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

The techniques described herein may facilitate the partial or complete removal of coatings, such as EBC, or other overlying material, from silicon-bearing substrates, with low mechanical force relative to conventional coating removal techniques. The term “coating” as used herein simply refers to a quantity of material disposed over another material; this term does not imply anything about the nature of the material, in particular as to whether the overlying material forms a continuous layer on the underlying material. Thus a “coating” as that term is used herein may be continuously or discretely disposed on the underlying material (“substrate”). The term “silicon-bearing” is used herein to mean any material that includes, but is not limited to, silicon. Examples of such materials include without limitation elemental silicon, alloys and solid solutions that include silicon as a component, and compounds that include silicon.

Referring to the FIGURE, an article 100 in accordance with the techniques disclosed herein generally includes a first material 102 in contact with a second material 104. In certain embodiments, article 100 is a component of a gas turbine assembly, such as, for example, a combustion liner, transition piece, shroud, vane, or blade. First material 102 comprises silicon. In some embodiments, first material 102 includes elemental silicon; an alloy that includes elemental silicon; a silicide; silicon carbide; silicon nitride, or a combination that includes one or more of these example materials. In a particular embodiment, article 100 includes a substrate, with first material 102 disposed over substrate 106, either directly in contact or with one or more interposed coatings (not shown). For illustrative purposes, in one embodiment, substrate 106 includes silicon carbide, silicon nitride, or combinations of one or more of these; one example is wherein substrate 106 includes a ceramic matrix composite (CMC). The CMC includes a ceramic material such as silicon carbide, silicon nitride, or combinations of one or more of these. A particular example of such CMC is a material that includes a matrix and a reinforcement phase, where the matrix includes silicon carbide and the reinforcement phase includes silicon carbide fibers.

Second material 104 includes an oxide including silicon. This oxide may include, for example, silica, a silicate, or a combination including one or both of these. In one example, the oxide of second material 104 is the product of oxidation of one or more components of first material 102, such as the so-called “thermally grown oxide” (often abbreviated “TGO”) that forms on silicon-bearing coatings and/or substrates during high temperature service in oxidizing environments. For instance, where substrate 106 includes a CMC, first material 102 may be disposed over substrate 106 as a bond coat comprising silicon, often elemental silicon; the silicon in the bond coat oxidizes during service to form a silicon-bearing TGO, which in the parlance of this disclosure corresponds to second material 104.

In some embodiments, article 100 further includes a third material 108 disposed over second material 104, either directly in contact with second material 104 or with one or more interposed layers (not shown). Third material 108 includes an oxide, such as one or more of the oxide materials commonly used in the art for thermal barrier coating (TBC) and/or environmental barrier coating (EBC). Examples include silicates, such as silicates including one or more rare earth elements; aluminosilicates, such as aluminosilicate compounds including one or more alkaline-earth elements; and zirconia, such as yttria-stabilized zirconia. In one illustrative example, substrate 106 includes a CMC such as a CMC including silicon carbide; first material 102 includes a silicon-bearing bond coat; and third material 108 includes an oxide top coat commonly used in EBC. The second material 104, in this example, is a silicon-bearing oxide, such as a TGO, disposed between the bond coat and the top coat.

A method for removing a coating, such as the oxide layers of an EBC, or other overlying material from a silicon-bearing substrate, such as a CMC, includes promoting a reaction between the silicon of first material 102 with the silicon-bearing oxide of second material 104 at elevated temperature. This reaction between first material 102 and second material 104 produces silicon monoxide vapor, which has a very high equilibrium pressure compared to other relevant reactions, such as thermal decomposition of silica. The reaction involves equilibrium among 4 phases, including the oxide, the silicon, the silicon monoxide, and oxygen. Where silicon monoxide vapor product is removed from contact with the first material 102 and second material 104 rapidly enough to avoid buildup to equilibrium vapor pressure, and where the partial pressure of oxygen remains at levels sufficiently low to promote the reaction, the reaction will continue to run for as long as these temperature and pressure conditions are maintained, until second material 104 is spent. This reaction essentially vaporizes the connection between substrate 106 and any material disposed over substrate 106, such as third material 108, allowing this material to become detached from the substrate 106 with little or no mechanical force. Free edges of article 100, along with surface-connected cracks, pores, and any other openings in third material 108, allow the SiO reaction product to escape, preventing buildup of reaction product and accelerating the removal process.

Based on the above mechanism, one embodiment of a method in accordance with the present disclosure includes heating article 100 to a processing temperature in an environment having a partial pressure of oxygen that is less than an equilibrium partial pressure of oxygen for chemical equilibrium between first material 102 and second material 104 at the processing temperature. In some embodiments, this heating is performed in a vacuum environment, that is, in an environment having a total pressure that is less than atmospheric pressure. In some embodiments, the total pressure of the vacuum environment is less than about 10⁻² torr (1.3 Pa), and in certain embodiments the total pressure is less than about 10⁻⁵ torr (10⁻³ Pa). A lower total pressure helps to drive faster reaction rates. Similarly, the rate of the reaction is also dependent on temperature, but to a stronger degree. A higher temperature results in faster reaction kinetics. For example, to completely remove a 20 micrometer thick layer of silica-bearing TGO to a distance of about 1.3 cm (0.5 inch) from a free edge of a coated part, heating in vacuum to a temperature of 1200 degrees Celsius requires about 32 hours, a temperature of 1300 degrees Celsius requires about 6 hours, and a temperature of 1400 degrees Celsius requires about 1.2 hours. In some embodiments, the processing temperature is at least about 1200 degrees Celsius, and in particular embodiments, the processing temperature is at least about 1300 degrees Celsius. Of course, a practical upper limit for temperature may be determined by the particular circumstances; for instance, if the substrate 106 includes temperature-sensitive material, such as elemental silicon, it may be desirable to remain below the melting point of this material to avoid damaging the substrate 106.

Heating of article 100 to maintain a temperature as described above may be continued for a time until a desired amount of material removal has taken place. The selected time depends on several factors, such as the temperature and pressure of the heating environment, the size of the article to be treated, and the availability of escape paths for the reaction product vaporizing away from the site of the reaction between first material 102 and second material 104. If essentially all of at least one of the reaction products is consumed, then any overlying materials, such as third material 108, may be readily removed from substrate 106 by simply sliding it away from substrate 106 if the geometry allows; in some cases, such as where the overlying material completely encases substrate 106, or where geometry is complex, the overlying material may have to be fractured before it can be removed in one or more sections. In some embodiments, it may not be necessary to completely vaporize first and/or second materials; the connection they provide between substrate 106 and overlying materials may be degraded to a point where only a small mechanical force is needed to remove the overlying material, significantly reducing the risk of damage to the CMC substrate 106. Any convenient method for removing the overlying material may be applied, such as grit blasting, water impingement, air impingement, or other appropriately selected method that will not unduly damage the substrate 106.

### EXAMPLES

The following examples are presented to further illustrate non-limiting embodiments of the present invention.

To further illustrate the features described above, a particular embodiment of the invention is a method for removing a coating from an article. The method includes heating the article to a processing temperature at least about 1200 degrees Celsius in a vacuum having a total pressure less than about 10⁻² torr (1.3 Pa). The article 100 includes a substrate 106 comprising a ceramic matrix composite, the composite comprising silicon carbide, silicon nitride, or a combination comprising one or both of the aforementioned; a first material 102 disposed over the substrate 106 and including elemental silicon, an alloy comprising elemental silicon, a silicide, or a combination comprising one or more of the aforementioned; a second material 104 in contact with the first material 102, the second material comprising silica, a silicate, or a combination comprising one or both of the aforementioned, and a third material 108 disposed over the second material 104, the third material 108 comprising a rare earth silicate, an aluminosilicate, zirconia, or a combination comprising one or more of the aforementioned. The article 100 is heated at the processing temperature in the described environment until a desired degree of reaction between first material 102 and second material 104 has occurred, and then the third material 108 is removed from substrate 106.

A CMC substrate of silicon-carbide matrix with silicon carbide fiber reinforcement was coated with a bondcoat of elemental silicon and an oxide topcoat, and the coated CMC was subjected to about 2000 total hours of exposure to steam at about 1315 degrees Celsius. The exposed article was then placed in a vacuum furnace and heated to a processing temperature of about 1300 degrees Celsius for 75 hours. Upon cooling, complete separation of the topcoat from the substrate was observed. The topcoat was easily slid off of the surface of the substrate.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for removing a coating from an article, the method comprising:
heating an article to a processing temperature, the article comprising
a substrate; a bond coat comprising a first material disposed over the substrate and in contact with a second material, the first material comprising silicon, and the second material disposed over the first material and comprising an oxide comprising silicon; and
a coating comprising a third material disposed over the bond coat;
wherein the heating is performed in an environment having a partial pressure of oxygen that is less than an equilibrium partial pressure of oxygen for chemical equilibrium between the first material and the second material at the processing temperature;
wherein the processing temperature is below the melting temperature of any material included in the substrate;
reacting the first and second materials to form silicon monoxide vapor and consume essentially all of the oxide of the second material; and
removing the coating from the substrate.

2. The method of claim 1, wherein the environment is a vacuum.

3. The method of claim 1, wherein the environment is a vacuum having a total pressure less than about 10⁻² torr (1.3 Pa).

4. The method of claim 3, wherein the total pressure is less than about 10⁻⁵ torr (10⁻³ Pa).

5. The method of claim 1, wherein the processing temperature is at least about 1000 degrees Celsius.

6. The method of claim 1, wherein the processing temperature is at least about 1200 degrees Celsius.

7. The method of claim 1, wherein the processing temperature is at least about 1300 degrees Celsius.

8. The method of claim 1, wherein the first material comprises elemental silicon, an alloy comprising elemental silicon, a silicide, silicon carbide, silicon nitride, or a combination comprising one or more of the aforementioned.

9. The method of claim 1, wherein the oxide comprises silica, a silicate, or a combination comprising one or more of the aforementioned.

10. (canceled)

11. The article of claim 1, wherein the substrate comprises silicon carbide, silicon nitride, or a combination comprising one or both of the aforementioned.

12. The article of claim 1, wherein the substrate comprises a ceramic matrix composite, the composite comprising silicon carbide, silicon nitride, or a combination comprising one or both of the aforementioned.

13. The method of claim 1, wherein the third material comprises an oxide.

14. The method of claim 13, wherein the oxide of the third material comprises a rare earth silicate, an aluminosilicate, zirconia, or a combination comprising one or more of the aforementioned.

15. A method for removing material from an article, the method comprising:
heating an article to a processing temperature at least about 1200 degrees Celsius in a vacuum having a total pressure less than about 10⁻² torr (1.3 Pa),
wherein the article comprises
a substrate comprising a ceramic matrix composite, the composite comprising silicon carbide, silicon nitride, or a combination comprising one or both of the aforementioned,
a bond coat comprising a first material disposed over the substrate, the first material comprising elemental silicon, an alloy comprising elemental silicon, a silicide, or a combination comprising one or more of the aforementioned,
a second material in contact with the first material, the second material comprising silica, a silicate, or a combination comprising one or both of the aforementioned, and
a third material disposed over the bond coat, the third material comprising a rare earth silicate, an aluminosilicate, zirconia, or a combination comprising one or more of the aforementioned;
reacting the first and second materials to form silicon monoxide vapor and consume essentially all of the oxide of the second material; and
removing the third material from the substrate.
